(19) United States
(12) Patent Application Publication
(10) Pub. No.: US 2005/0213157 A1
(43) Pub. Date: Sep. 29, 2005

(54) Printer system with halftone monochromatic process and method thereof

(75) Inventor: Wen-Cheng Ho, Shigang Shiang (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/076,934

(22) Filed: Mar. 11, 2005

(30) Foreign Application Priority Data
Mar. 24, 2004 (TW) 093107962

(51) Int. Cl. H04N 1/405

(52) U.S. Cl. 358/3.03; 358/3.05

(57) ABSTRACT

A printer system with halftone monochromatic process and method thereof. An image printed by the printer system consists of a two-dimensional array of pixels in rows. The printer system includes an update device, a threshold device and an error determinator. The update device has a first input terminal to receive a pixel to be printed, a second input terminal to receive a feedback error signal for generating a corrected pixel. The threshold device is connected to the update device so as to generate a print signal as a value of the corrected pixel exceeds a predetermined value, or conversely a non-print signal. The error determinator generates the feedback error signal in accordance with the signal generated by the threshold device, the corrected signal and previously printed pixels.

### BACKGROUND OF THE INVENTION

1. Field of the Invention

The invention relates to a technical field of printer and, more particularly, to a printer system with halftone monochromatic process and method thereof.

2. Description of Related Art

At practical printing of a printer, due to inherent low resolution, human eyes cannot distinguish individual dot differences from a group of dots densely arranged on a small area but receive an average reflectivity of the dots. Accordingly, different gray levels in a printing process can be formed by controlling the density on the dots. Typically, half-tone techniques can determine a position for individual dot to obtain a desired gray level and reduce uncomfortable viewing to human eyes in frames. Half-tone techniques essentially have two types of dithering and error diffusion.

Dithering essentially represents different gray level values respectively by a fixed pattern, namely, one pattern to one gray level value. As shown in FIG. 1, five patterns correspond to gray values, 0/4, 1/4, 2/4, 3/4 and 4/4 respectively. An advantage of dithering is simply and easy to implement associated circuitry. However, it is likely for the frame to have a known fixed pattern effect, and different pattern effects may be formed based on the selected patterns, resulting in that human eyes may have an uncomfortable view.

Compared to dithering, error diffusion has no aforementioned problem on a printed graph, so that a better image can be presented to human eyes. Error diffusion conceptually diffuses an error, which is generated as converting a pixel on a source image into a corresponding print gray level (bi-level), to neighboring lattices when gray levels for the source image is over bi-level, such that dots in the neighboring lattices can visually have gray levels close to that of the pixel of the source image. As shown in FIG. 2, an error of pixel 0 is diffused to neighboring pixels, where h1, h2, . . . , h12={7/48, 5/48, 3/48, 5/48, 7/48, 5/48, 3/48, 1/48, 3/48, 5/48, 3/48, 1/48}.

A conventional system architecture of error diffusion is shown in FIG. 3, where X indicates graylevel values of pixels of an input source image, whose values have more than two graylevels, and B indicates graylevel values of an output image to a printer, which are bi-level (inkjet or no inkjet). Since the number of graylevels of the input image is more than that of the output image, one-to-one relationship does not exist. The threshold typically is set as a half of the most value among graylevel values of input image pixels, thereby determining an output B of gray level values to a printer. In this way, an error E is generated in each input and output and diffused to next input image pixels. To achieve this, the error E is fed back to next input image pixels through a filter. Accordingly, the feedback is repeated so as to obtain better printed image than dithering. However, such a system architecture does not consider any feature such as sizes and shapes of dots of implemented output devices, which causes ink waste and affects print quality because the print gray level values and the feedback errors cannot be obtained accurately.

Therefore, it is desirable to provide an improved method to mitigate and/or obviate the aforementioned problems.

### SUMMARY OF THE INVENTION

The object of the present invention is to provide a printer system with halftone monochromatic process and the method thereof, which can avoid the prior ink waster and accurately obtain the print gray level values and the feedback errors to thus increase print quality.

In accordance with one aspect of the present invention, there is provided a printer system with halftone monochromatic process. An image printed by the printer system is consisted of a two-dimensional array of pixels, where notation (i,j) indicates a pixel on i-th row and j-th column, referred to as a pixel (i,j), and P(i,j) indicates a gray level value of the pixel (i,j). The printer system essentially includes an update device, a threshold device and an error determinator. The update device has a first input terminal to receive the value P(i,j) of the pixel (i,j) sent by the printer system for printing and a second input terminal to receive a feedback error signal, which is obtained after the value P(i,j) of the pixel (i,j) passes through the threshold device, the error determinator and a filter, and the update device also corrects values of pixels (i,j+1), (i+1,j−1), (i+1,j) and (i+1,j+1) in accordance with the feedback error signal. The threshold device generates a print signal as the value P(i,j) of the pixel (i,j) exceeds a predetermined value, or conversely a non-print signal. The error determinator generates the feedback error signal in accordance with the signal generated by the threshold device, the value P(i,j) of the pixel (i,j) and previously printed pixel values.

In accordance with another aspect of the present invention, there is provided a method of printing halftone monochrome in a printer system. An image printed by the printer system is consisted of a two-dimensional array of pixels, where (i,j) indicates a pixel on i-th row and j-th column, referred to as a pixel (i,j), and P(i,j) indicates a gray level value of the pixel (i,j). The method includes an input step, a determining step and an error generating step. The input step receives the value P(i,j) of the pixel (i,j) sent by the printer system for printing and corrects values of pixels (i,j+1), (i+1,j−1), (i+1,j) and (i+1,j+1) after the value P(i,j) of the pixel (i,j) is subjected to a threshold comparing process, an error determining process and a filtering process. The determining step generates a print signal as the value P(i,j) of the pixel (i,j) exceeds a predetermined value, or conversely a non-print signal. The error generating step generates the feedback error signal in accordance with the signal generated in the determining step, the value P(i,j) of the pixel (i,j) and previously printed pixel values.

Other objects, advantages, and novel features of the invention will become more apparent from the following detailed description when taken in conjunction with the accompanying drawings.

### BRIEF DESCRIPTION OF THE DRAWINGS

FIG. 1 illustrates patterns of a conventional dithering method;

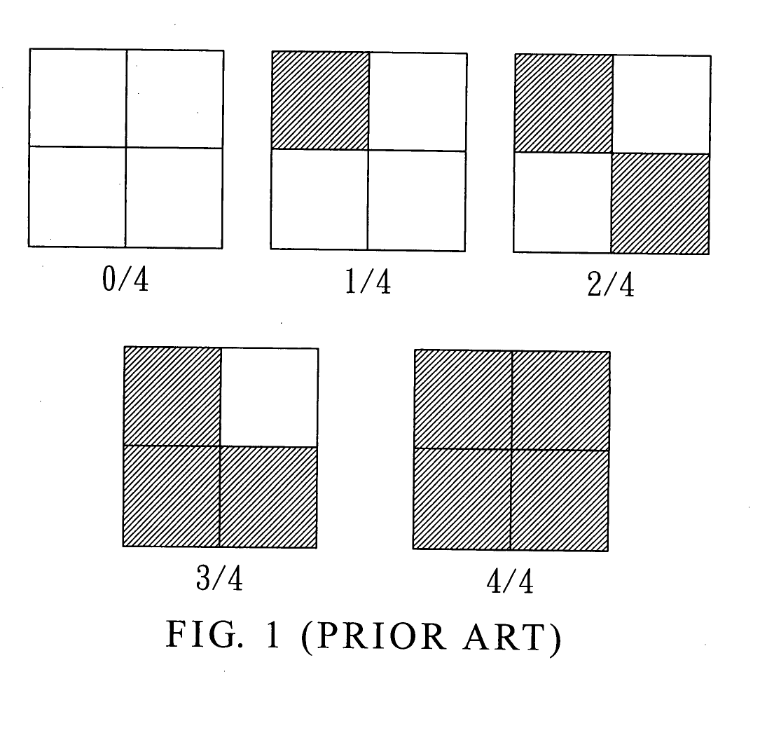

FIG. 2 is a schematic diagram of conventional error diffusion method;

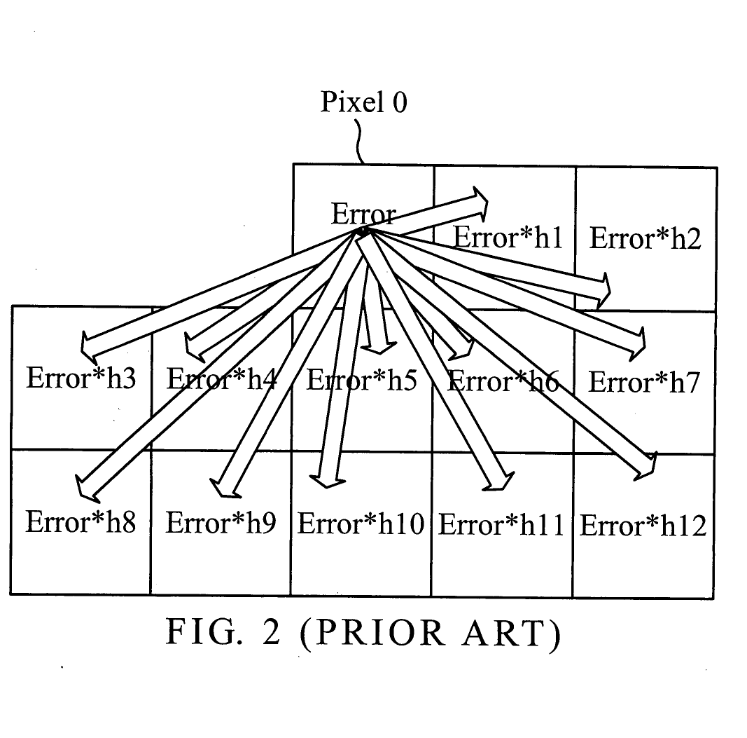

FIG. 3 is a block diagram of a conventional error diffusion system;

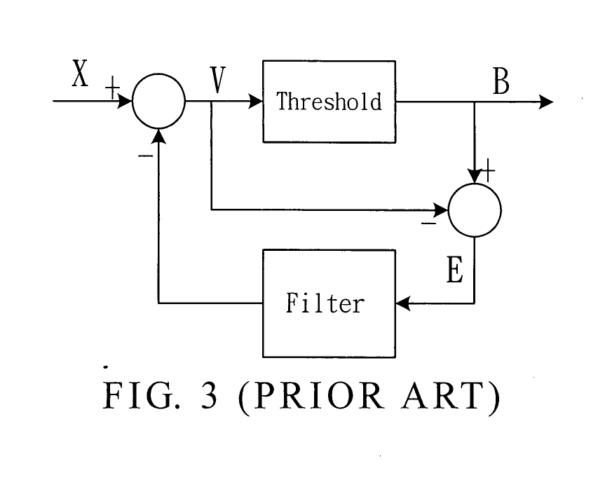

FIG. 4 is a block diagram of a printer system with halftone monochromatic process in accordance with the invention;

FIG. 5 is a schematic view of monochromatically printed dots in overlapping in accordance with the invention;

FIG. 6 is a schematic view of an error correction of monochromatically printed dots in accordance with the invention;

FIG. 7 is a schematic view of another error correction of monochromatically printed dots in accordance with the invention; and

FIG. 8 is an error correction table for the printer system in accordance with the invention.

### DETAILED DESCRIPTION OF THE PREFERRED EMBODIMENT

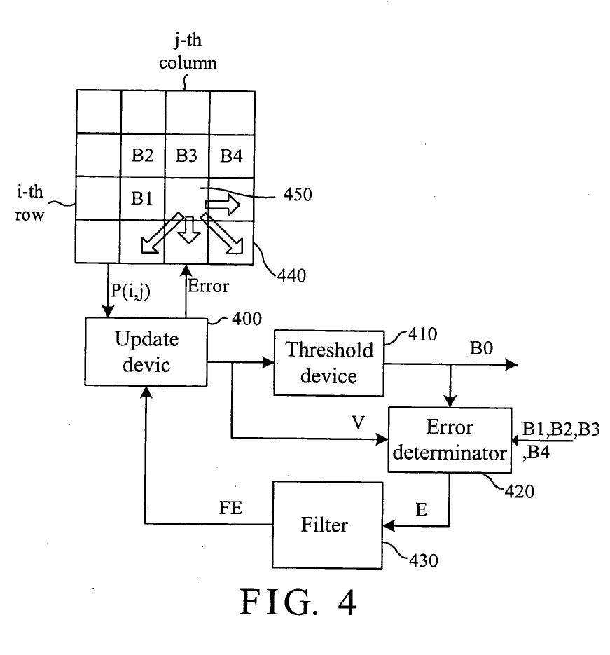

FIG. 4 is a block diagram of a printer system with halftone monochromatic process in accordance with the invention. As shown, an image 440 printed by the printer system consists of a two-dimensional array of pixels, wherein number 450 indicates a pixel on i-th row and j-th column of the image 440, referred to as a pixel (i,j), and notations B1 to B4 indicate previously printed pixels at positions shown in FIG. 4 with respect to the pixel (i,j).

The printer system essentially includes an update device 400, a threshold device 410, an error determinator 420 and a filter 430. The update device 400 has a first input terminal to receive a value P(i,j) of the pixel (i,j) sent by the printer system for printing and a second input terminal to receive a feedback error signal for correcting values of pixels (i,j+1), (i+1,j−1), (i+1,j) and (i+1,j+1). In this embodiment, after the pixel (i,j) is processed by the update device 400, an error is generated and diffused to next processed pixels (i,j+1), (i+1,j−1), (i+1,j) and (i+1,j+1).

The threshold device 410 is connected to the update device 400 in order to generate a print signal as the value P(i,j) of the pixel (i,j) exceeds a predetermined value, or conversely a non-print signal. The output signal of the threshold device 410 corresponding to the pixel (i,j) is denoted as B0. When the value P(i,j) of the pixel (i,j) exceeds a predetermined value, B0=1.

The error determinator 420 generates an error signal E in accordance with the signal B0 generated by the threshold device 410, values of the previously printed pixels B1 to B4 and the value P(i,j) of the pixel (i,j). The filter 430 has an input terminal connected to the error determinator 420 in order to receive the error signal E, and an output terminal connected to the second input terminal of the update device 400 to thus generate a feedback error signal FE to correct the values of the pixels (i,j+1), (i+1,j−1), (i+1,j) and (i+1,j+1).

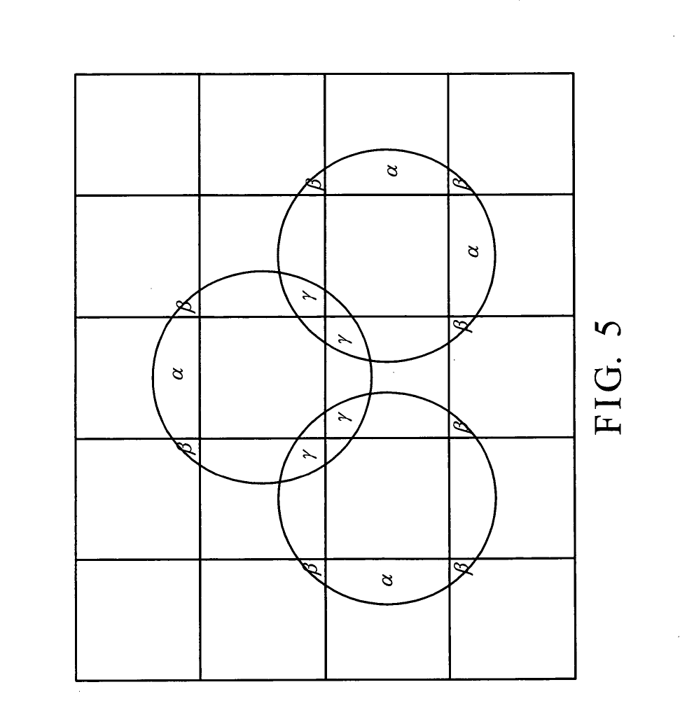

In a practical printer system, printed dots are not square but appropriately round. For comfortable viewing to human eyes, a printed dot has to fill up a lattice. To achieve this, a dot formed has a diameter greater than a diagonal of a lattice. Suppose that a ratio ρ of a diameter of a dot to a diagonal of a lattice is given, in this case, some areas of the dot are out of the lattice, which can form overlapped areas (by an overlapped proportion Γ) if another dot is close to the lattice, as shown in FIG. 5. Upon geometry, a proportion α of the areas outside the lattice and the overlapped proportion Γ can be computed by the following equations:

$$\begin{matrix}α = \frac{1}{4} \sqrt{2 {ρ}^{2} - 1} + \frac{{ρ}^{2}}{2} {sin}^{- 1} ( \frac{1}{\sqrt{2} ρ} ) - \frac{1}{2} \\ β = \frac{π {ρ}^{2}}{8} - \frac{{ρ}^{2}}{2} {sin}^{- 1} ( \frac{1}{\sqrt{2} ρ} ) - \frac{1}{4} \sqrt{2 {ρ}^{2} - 1} + \frac{1}{4} \\ γ = \frac{{ρ}^{2}}{2} {sin}^{- 1} ( \sqrt{\frac{{ρ}^{2} - 1}{{ρ}^{2}}} ) - \frac{1}{2} \sqrt{{ρ}^{2} - 1} - β .\end{matrix} \qquad ( 1 )$$

By practically measuring a printed dot, it is obtained that ρ=1.25 [symbol] α=33%, β=3%, Γ=10%, which is obviously shown that the effect caused by the overlapped areas cannot be omitted.

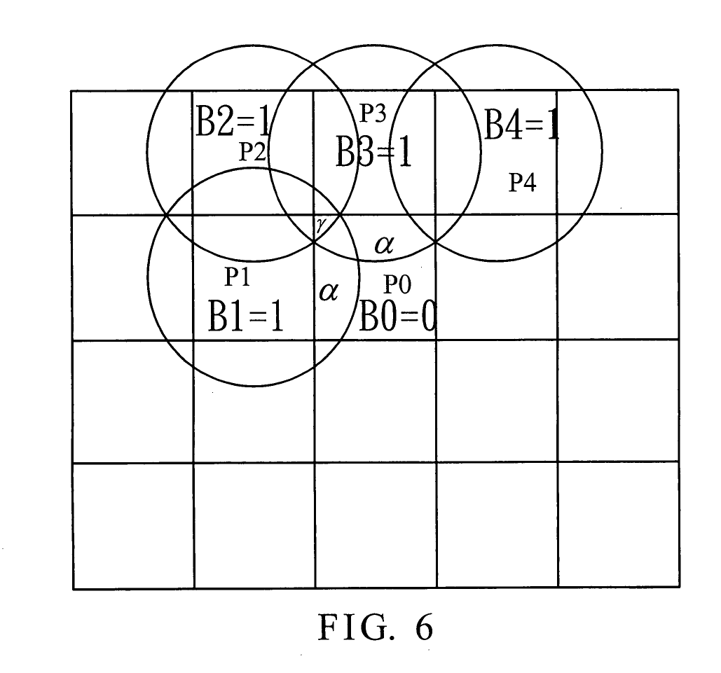

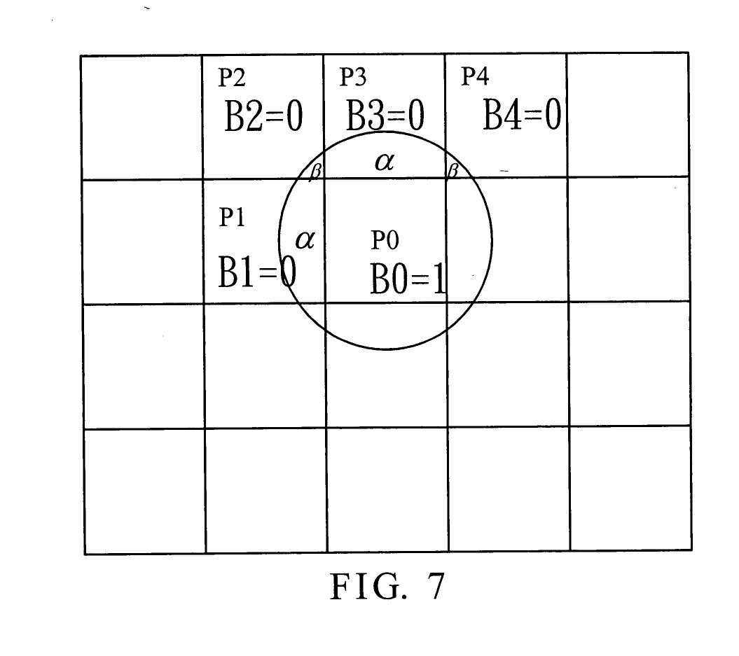

However, the conventional system architecture of error diffusion does not consider the sizes and shapes of dots, so as not to consider that dots surrounding a current printed dot can affect gray level of the current dot in practice. Thus, a gray level still exists even if no droplet of ink ejects on position of the current dot (B0=0). Accordingly, error computation of the current dot requires in consideration of the surrounding dots. As shown in FIG. 6, when B1 to B4 are printed completely (B1=B2=B3=B4=1) and a currently processing pixel (i,j) is not printed (B0=0), a corrected error is given as:
Error 1=P(i,j)−2α+Γ (2).
Similarly, the pixel (i,j) to be printed can also affect the surrounding dots. As shown in FIG. 7, when B1 to B4 are not printed (B1=B2=B3=B4=0) and a currently processing pixel (i,j) is printed (B0=1), a corrected error is given as:
Error 2=1−P(i,j)+2α+2β (3).

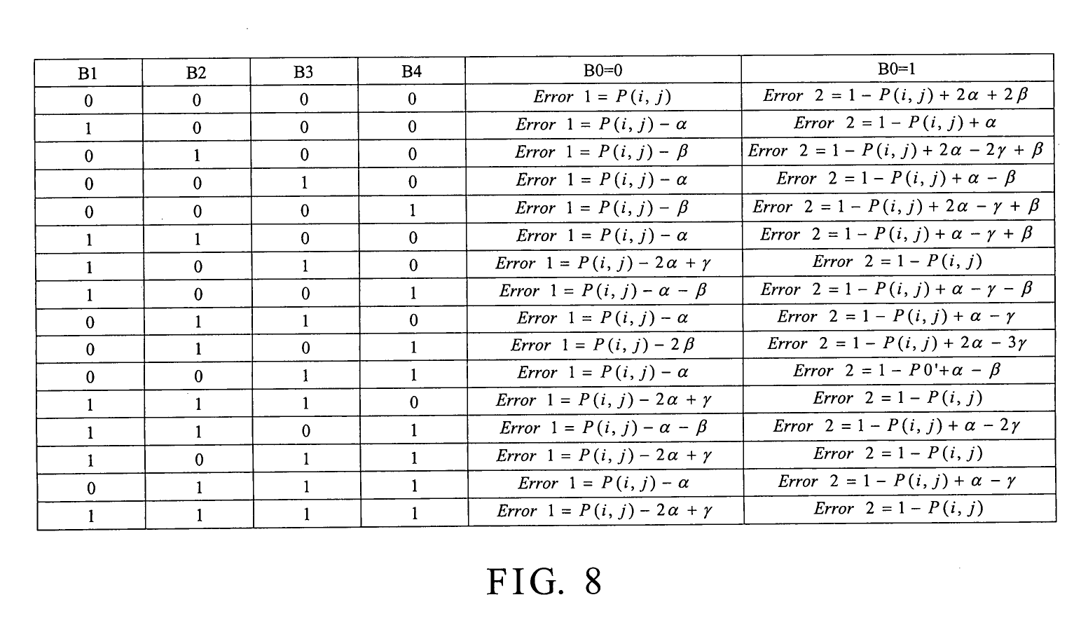

All corrected errors corresponding to the pixels (i,j), (i,j−1), (i−1,j−1), (i−1,j) and (i−1,j+1) are shown in FIG. 8. As cited, upon the dot feature of a printer, the invention accurately computes each pixel error so that image gray distribution can be printed accurate. Thus, ink waste caused by the prior halftone techniques is avoided, and the print gray level values and the feedback errors are obtained accurately, thereby increasing print quality.

Although the present invention has been explained in relation to its preferred embodiment, it is to be understood that many other possible modifications and variations can be made without departing from the spirit and scope of the invention as hereinafter claimed.

1. A printer system with halftone monochromatic process, an image printed by the printer system consisting of a two-dimensional array of pixels, where pixel (i,j) indicates a pixel on i-th row and j-th column, the printer system comprising:
an update device, which has a first input terminal to receive the pixel (i,j) sent by the printer system for printing and a second input terminal to receive a feedback error signal for correcting corrects values of pixels (i,j+1), (i+1,j−1), (i+1,j) and (i+1,j+1);
a threshold device, which is connected to the update device in order to generate a print signal when a value of the pixel (i,j) exceeds a predetermined threshold, or conversely generate a non-print signal; and
an error determinator, which is connected to the update device and the threshold device in order to generate the feedback error signal in accordance with the signal generated by the threshold device, the value of the pixel (i,j) and previously printed pixel values.

2. The printer system as claimed in claim 1, further comprising a filter, which has an input terminal connected to the error determinator in order to receive the feedback error signal and an output terminal connected to the second input terminal of the update device.

3. The printer system as claimed in claim 1, wherein the error determinator uses a lookup table to generate the feedback error signal in accordance with the signal generated by the threshold device, the value of the pixel (i,j) and the previously printed pixel values.

4. A method of printing halftone monochrome in a printer system, an image printed by the printer system and consisted of a two-dimensional array of pixels, where (i,j) indicates a pixel on i-th row and j-th column, referred to as a pixel (i,j), the method comprising:
an input step, which repeatedly receives a value of the pixel (i,j) sent by the printer system for printing and a feedback error signal to correct values of pixels (i,j+1), (i+1,j−1), (i+1,j) and (i+1,j+1) until all pixels of the image are processed completely;
a determining step, which generates a print signal as the value of the pixel (i,j) exceeds a predetermined threshold, or conversely generates a non-print signal; and
an error generating step, which generates the feedback error signal in accordance with the signal generated in the determining step, the value of the pixel (i,j) and previously printed pixel values.

5. The method as claimed in claim 4, further comprising a filtering step, which filters the feedback error signal generated in the error generating step before the input step receives the feedback error signal.

6. The method as claimed in claim 4, wherein the error generating step uses a lookup table to generate the feedback error signal in accordance with the signal generated in the determining step, the value of the pixel (i,j) and the previously printed pixel values.
